(19) United States
(12) Patent Application Publication
(10) Pub. No.: US 2023/0088118 A1
(43) Pub. Date: Mar. 23, 2023

(54) CONNECTING ELEMENT

(71) Applicant: Karl KALS, Gratwein/Straßengel (AT)

(72) Inventor: Karl KALS, Gratwein/Straßengel (AT)

(21) Appl. No.: 17/909,001

(22) PCT Filed: Feb. 25, 2021
(86) PCT No.: PCT/AT2021/060063

§ 371 Date: Sep. 2, 2022

(30) Foreign Application Priority Data
Mar. 3, 2020 (AT) A 52/2020
Sep. 25, 2020 (AT) A 50815/2020

(51) Int. Cl. F16B 12/44

(52) U.S. Cl. CPC F16B 12/44

(57) ABSTRACT

According to the invention, a connecting element (1) is provided, comprising a base plate (2), which is connected to at least a first receiving element (3) and a second receiving element (4), wherein the first receiving element (3) and the second receiving element (4) each have a first strip (7) and a second strip (8), which are each arranged substantially perpendicular to the base plate (2), wherein the first and the second strip (7,8) of the first receiving element (3) and the base plate (2) delimit a first receiving groove (9), which is designed to receive a separating element (23), and the first and the second strip (7,8) of the second receiving element (4) and the base plate (2) delimit a second receiving groove (10), which is designed to receive a separating element (23).

The invention relates to a connecting element for separating elements, in particular in drawers, comprising a base plate which is connected to at least a first receiving element and a second receiving element.

Many possibilities are known from the prior art for dividing a container, e.g. a drawer, a shelf or another area, so that separate departments are created which can be used to accommodate different objects, e.g. cutlery or tools. Usually, prefabricated elements are used, which have several subdivisions that are firmly connected to one another. These prefabricated elements are simply placed in the drawer or compartment and provide a division. However, these devices have the disadvantage that they are rigid and cannot be adjusted to the drawer, so that the device only fits well in the drawer if the dimensions of the dividers and the drawer are fitting. With a drawer that is larger, the drawer divider is not adequately secured and may move unintentionally. Furthermore, space in the drawer remains unused and the subdivisions themselves cannot be adapted to personal needs in a situation-specific manner, for example if a few larger subdivisions are required instead of many small subdivisions.

In order to solve these problems, drawer dividers are known, which consist of separating elements that are placed inside the drawer or are pressed against the walls of the drawer. The separating elements are usually essentially plate-shaped or rod-shaped. The length of the separating elements can also be changed in some known designs. Connecting elements known from the prior art are described for example in the documents DE 9315767 U1, DE 19628479 A1, EP 0747603 A1 and DE 2701786 A1.

The disadvantage of these known designs, however, is that the separating elements cannot be variably connected to one another. As a result, it is not possible to divide a drawer completely individually, but compromises always have to be found when designing the dividing elements.

It is therefore an object of the invention to provide a connecting element of the type mentioned at the beginning, which enables a division, in particular for drawers, to be constructed as modularly as possible. Furthermore, the separating elements should be able to be held firmly relative to one another.

According to the invention, a connecting element of the type mentioned at the beginning is provided, wherein the first receiving element and the second receiving element each have a first strip and a second strip, which are each arranged substantially perpendicular to the base plate, wherein the first and the second strip of the first receiving element and the base plate delimit a first receiving groove, which is designed to receive a separating element, and the first and the second strip of the second receiving element and the base plate delimit a second receiving groove which is designed to receive a separating element.

According to the invention, a base plate is provided which delimits a first groove in a U-shape with two strips and delimits a second groove in a U-shape with two further strips. Separating elements can be accommodated and held in these two grooves. As a result, the connection element makes it possible to introduce separating elements flexibly into the grooves, in order to thereby enable a variable and modular arrangement of separating elements. The strips are preferably arranged in such a way that they do not touch one another at least when there is no separating element in the receiving grooves.

The plate, a basic element, essentially extends in a plate plane, with the thickness of the plate is small in relation to its length or width, both lying in the plate plane. The plate can, for example, be essentially square, rectangular or round when viewed from above. In this case, it is preferably provided that the plate is designed essentially rotationally symmetrical, particularly preferably 4-fold rotationally symmetrical. In this way, a connecting element can be provided in a simple manner, which can connect individual separating elements to one another at an angle of 90°, 180° or 270°.

The length of the strips extends away from the plate or the plate plane, respectively, with this longitudinal extension being arranged essentially perpendicularly to the plate plane. The length of the strips is preferably greater than the width and the depth of the strips. Further, the two strips of a receiving element are preferably constructed with mirror symmetry.

In a preferred embodiment it is provided that the connecting element is designed to be essentially rotationally symmetrical in a view from below, particularly preferably 4-fold rotationally symmetrical.

Provision is preferably made for the first and/or the second strip of the first and/or the second receiving element to be arranged in a resilient manner. All strips are preferably arranged in a resilient manner. The spring force preferably acts substantially parallel to the base plate and in the direction of the receiving groove, such that a separating element can be clamped in the receiving groove by the spring force of the two strips delimiting the receiving groove and can thereby be held. The spring force can be provided by different configurations, for example by arranging a spring element or by forming the strips from a flexible material.

It is preferably provided here that the strips are designed in such a way that they allow a small amount of backlash relative to the base plate in a plane parallel to the base plate, as a result of which a spring force is provided when the strip is pressed out of the original position. For example, the strip can be made of a soft material such as e.g. a plastic, which allows a low mobility of the strip. Provision can also be made for the strip to be movably connected to the base plate, as a result of which the spring force is brought about.

In addition to the two strips, the first and the second receiving element preferably have a bridge between the strips in order to connect them to one another. A U-shape is formed in this way, wherein it is preferably provided that the bridge of the receiving element is connected to the base plate or can be connected to it. The bridge can also be formed in one piece with the base plate.

Provision is particularly preferably made for the two strips of a receiving element not to be connected to one another by a bridge over the entire height of the receiving groove, but only in an area facing the base plate, whereby a groove is created, which is running parallel to the strip length, limited only by the strips and perpendicular to the receiving groove. The receiving element is here also formed in a U-shape in a plan view. In this groove, for example separating elements, in particular plate-shaped separating elements, can be arranged which are higher than the strips and therefore protrude beyond the base plate of the connecting element, but can still be held by the receiving element in the front area of the receiving groove facing away from the base plate.

Furthermore, it is preferably provided that the base plate has at least one opening, for example a bore. An opening is particularly preferably arranged centrally in the base plate. Furthermore, further openings can be provided, especially in the edge areas and/or in the corner areas of the base plate. The opening(s) is/are used in particular to fasten the base plate (and thus the connecting element), for example to a drawer bottom or a shelf bottom.

It is preferably provided that the base plate is designed in one piece. Alternatively, the base plate can also be formed from two or more parts which are connected to one another, in particular detachably connected.

In a preferred embodiment it is provided that at least the first and/or the second receiving element is detachably connected to the base plate. As a result, the base plate can be connected to one or more receiving elements as required, which increases the usability of the connecting element. In this case, it is preferably provided that the base plate has one or more tabs which protrude from the base plate and which particularly preferably have a tab groove. The tabs are preferably substantially in the plane of the plate and are preferably thinner than a central area of the base plate. A receiving element can be pushed onto these tabs, which has a corresponding opening which can interact with the tab in order to connect the receiving element to the base plate. The tab groove may be compressed in the connected state, providing a force against the opening that secures the connection of the tab to the receiving element. In this case, the receiving element is preferably U-shaped, with the strips being connected to one another by a bridge having the opening. The base plate is particularly preferably rectangular or square and has a tab on each of the four sides for connection to a receiving element. Furthermore, it is preferably provided that the tabs are formed in one piece with the base plate.

Alternatively, the base plate can also have openings into which tabs of one or more receiving elements can be pushed in order to connect them to the base plate. Furthermore, the receiving elements can also alternatively or additionally be connected to the base plate by other connecting means, e.g. screws or magnets.

In a preferred embodiment, the base plate has first hook elements and the at least one receiving element in the edge regions has at least one, preferably two, protruding second hook elements which, when connected to the base plate, interact with the corresponding first hook elements of the base plate in order to prevent the tab or the receiving element, respectively, from being removed from the base plate in a plane substantially parallel to the base plate. Furthermore, it is preferably provided that the base plate has a first holding element and the receiving element has a second holding element. When connected, the first and second holding elements cooperate to establish a connection between the base plate and the receiving element. The first holding elements can be designed, for example, as cylindrical (spreading) bolts that protrude from the base plate. Furthermore, the first holding elements are preferably arranged at a distance from the edge of the plate. The second holding elements are preferably arranged on the tab of a receiving element and have, for example, a depression which interacts with the first clamping element, for example a bolt, in the connected state. The first and the second holding element can in this case interact in the form of a clamp connection or merely serve as a guide for inserting the tab into the groove of the base plate to facilitate hooking the hook elements. Sections of the tab are preferably trapezoidal in plan view, in order to enable an arrangement of four tabs in or on the base plate.

The second hook elements are formed, for example, by corner elements arranged in corners of the plate, which is preferably essentially rectangular or square in plan view, and which have, for example, a groove into which the first hook elements engage in the connected state.

The base plate preferably has a ground plate and a cover plate which can be connected to one another in a detachable manner. For example, the ground plate has a central opening and the cover plate has a central, protruding bolt, wherein the bolt protrudes into the opening in the connected state and is held in it with a force fit, for example. The ground plate and the cover plate preferably have essentially the same size when viewed from above.

The first clamping elements and the first hook elements are preferably formed on the ground plate. By connecting the ground plate to the cover plate, a secure, form-fitting connection of the base plate with the receiving element is created by preventing (non-destructive) detachment of the tab from the base plate in the plane of the plate using the hook elements, while (non-destructive) detachment of the tab in another level is prevented by the ground plate or the cover plate.

Provision is preferably made for the first strip and/or the second strip of the first and/or the second receiving element to have a connecting groove. The connecting groove is here arranged in the side of the strip delimiting the first or the second receiving groove and is preferably designed in the shape of a circular segment or rectangular or quadratic. This connecting groove serves in particular to hold a separating element, for example a rod, within the receiving groove. In order to enable the separating element to be held firmly, it is particularly preferably provided that two strips delimiting a receiving groove have connecting grooves in the sides delimiting the receiving groove, which are opposite one another and are preferably of substantially the same design. In this way, for example, a rod-shaped separating element can be held in a form-fitting manner on both sides in the receiving groove, wherein the height of the separating element, i.e. the distance from the base plate, being determined by the distance between the connecting groove(s) and the base plate. A receiving element preferably has more than one connecting groove. The axis of the connecting groove(s) preferably runs essentially parallel to the base plate.

Furthermore, it is preferably provided that the first and/or the second strip of the first and/or the second receiving element has at least one opening, for example a bore, which is preferably arranged transversely to the axis of the receiving groove. This opening can be used, for example, to fix a separating element arranged within the receiving groove or to reduce the weight of the connecting element.

In a further preferred embodiment, at least one cover element is provided, which is designed to engage in and cover the openings in the strips of the at least one receiving element. In this case, the cover element is preferably substantially in plan view rectangular in shape, with the length or width of the cover element preferably correspond to the dimension of the strip to be covered. In order to engage in the openings, the cover element preferably comprises one or more bolts, each of which is assigned to an opening. Each bolt preferably has a point for easier insertion into the openings.

For better fixing of the separating elements in the first or second receiving element, it is preferably provided that an elevation is arranged on the inside, i.e. the side facing the corresponding other strip, of at least one strip, which protrudes from the strip. The elevation is preferably of essentially wedge-shaped design in a side view. As a result of such an elevation, increased pressure is exerted on the separating element at certain points, and a better hold in the receiving groove is thereby achieved.

In order to be able to connect two separating elements to one another at right angles, it is preferably provided that the axis of the first receiving groove and the axis of the second receiving groove enclose an angle of approximately 90°. The axis of the receiving grooves lies in the middle between the two delimiting strips and runs parallel to the sides of the strips delimiting the receiving groove and parallel to the base plate. With this arrangement, one separating element can be received in the first receiving groove and another separating element can be received in the second receiving groove. In this case, the two separating elements are essentially perpendicular to one another.

In a preferred embodiment it is provided that the second strip of the first receiving element and the first strip of the second receiving element have opposing surfaces that are substantially parallel to one another and form a gap. The second strip of the first receiving element has at least one side which is essentially parallel to one side of the first strip of the second receiving element. The distance between the two sides is preferably substantially constant over the course of the sides and is preferably 0.25 mm or greater. In this way, in particular, play of the two strips relative to one another can be achieved, as a result of which a spring force is exerted on the separating elements arranged in the two receiving grooves when the separating elements are somewhat larger than the receiving groove. The gap between the two strips is further limited by the base plate.

Provision is preferably also made for the first receiving groove and the second receiving groove to lie on the same axis. The two receiving grooves are therefore arranged opposite one another and form a common groove that is not continuously delimited by strips. In this embodiment, the two receiving grooves or the respective strips form an alignment. On the one hand, this makes it possible to arrange a single separating element in the two opposite receiving grooves, for example in order to arrange a further separating element perpendicular to this. On the other hand, a first separating element can be received in the first receiving groove and a second separating element can be received in the second receiving groove, whereby an extension of the two separating elements is provided. The groove widths of two strips or additional strips can vary, i.e. they are each adapted to the material thickness of the separating elements.

It is preferably provided that a third receiving element connected to the base plate is provided, with the strips of the receiving elements and the base plate delimiting a cavity which is T-shaped in plan view.

It is preferably provided here that a fourth receiving element connected to the base plate is also provided, with the strips of the receiving elements and the base plate delimiting a cavity which is cross-shaped in plan view.

The third, the fourth and possibly further receiving elements can be designed or arranged corresponding to the first or the second receiving element as described above.

Further, a set is preferably provided according to the invention, comprising a connecting element in which at least one of the receiving elements can be detachably connected to the base plate, with at least one additional connecting piece being provided which can be (detachably) connected to the base plate. A connecting piece is preferably an angle element which can be connected to a base plate on two sides, as a result of which two base plates can be connected to one another. For connection, the angle element preferably has at least two tabs. In the connected state, the two base plates are preferably substantially in one plane. Alternatively, when connected, the two base plates lie in planes which enclose an angle, preferably of approximately 90°, with one another. Furthermore, for example, a terminal element, which has a preferably central strip, which preferably includes openings, is provided, which can be connected to a base plate.

Furthermore, the set can include a double tab, which is designed to connect two base plates lying in one plane to one another in such a way that the base plates touch one another. In order to connect two base plates arranged in different planes running parallel to one another, a side part is also preferably provided which has two parallel tabs which are each designed to be connected to a base plate. Furthermore, a fastening part is preferably provided which, in addition to a tab for connection to a base plate, has a fastening element, for example a vacuum pad, in order to (detachably) fix the fastening part and thus, if applicable, a base plate and other elements connected thereto.

Such additional elements make the set more flexible and additional divisions can be formed, for example in a drawer.

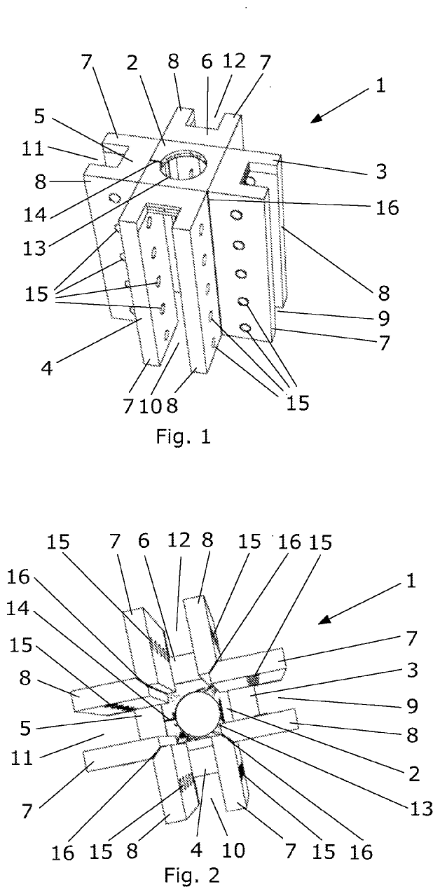

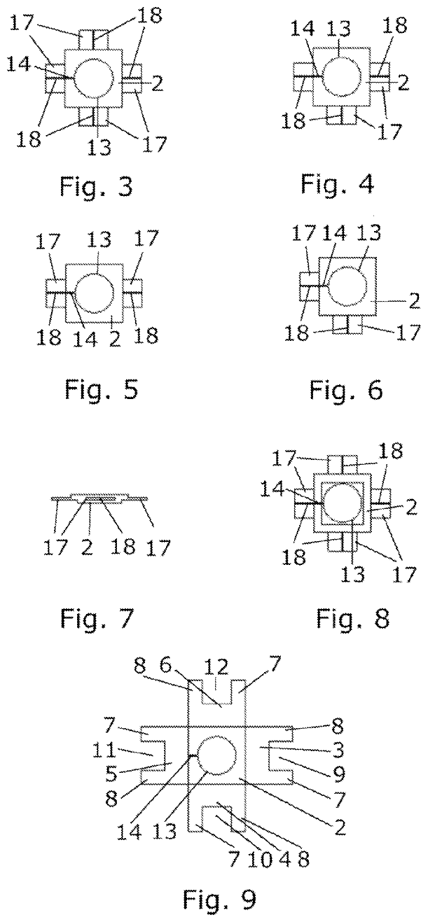

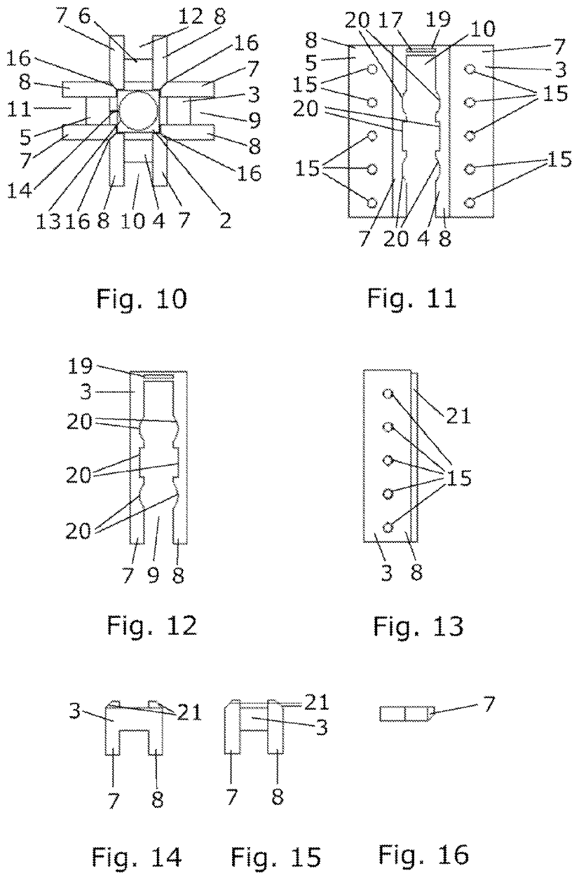

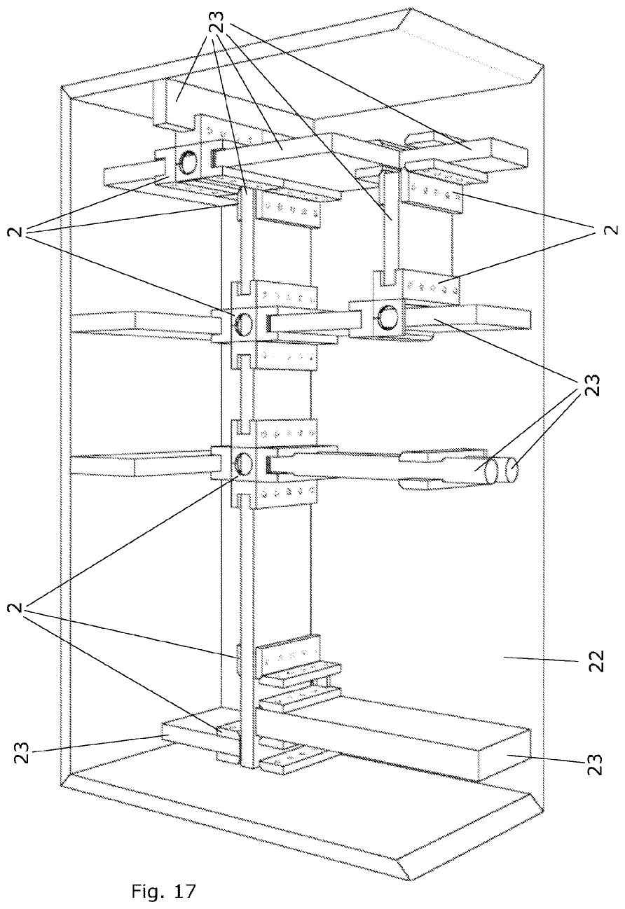

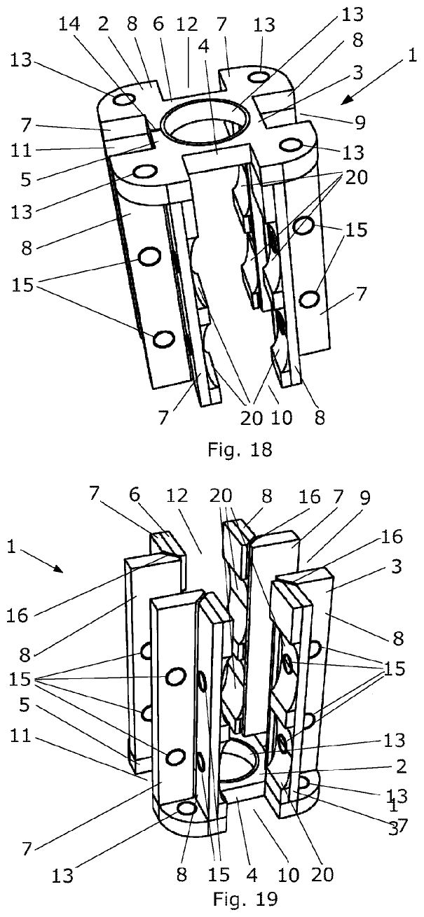

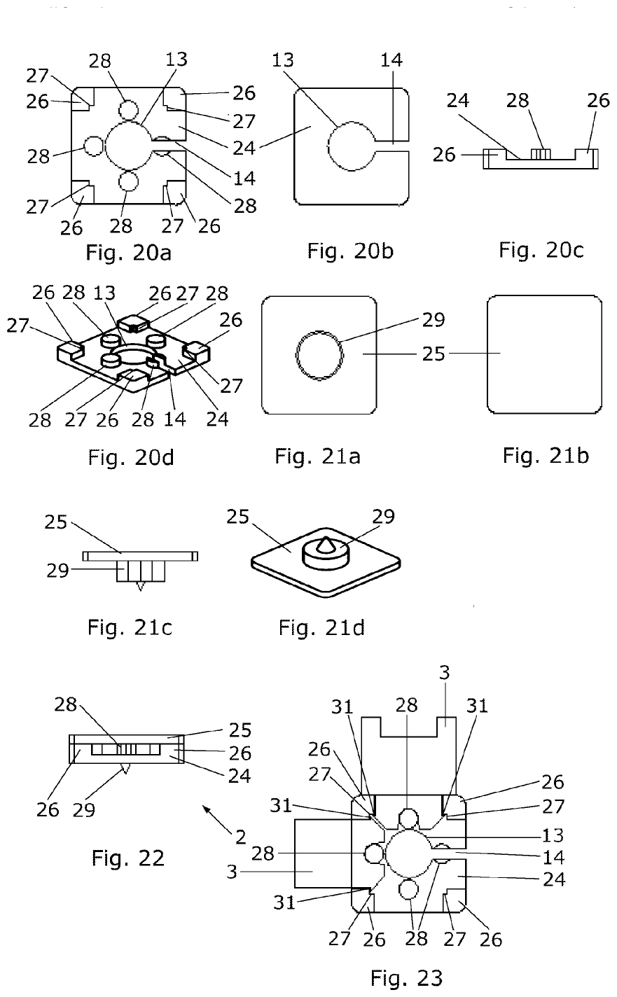

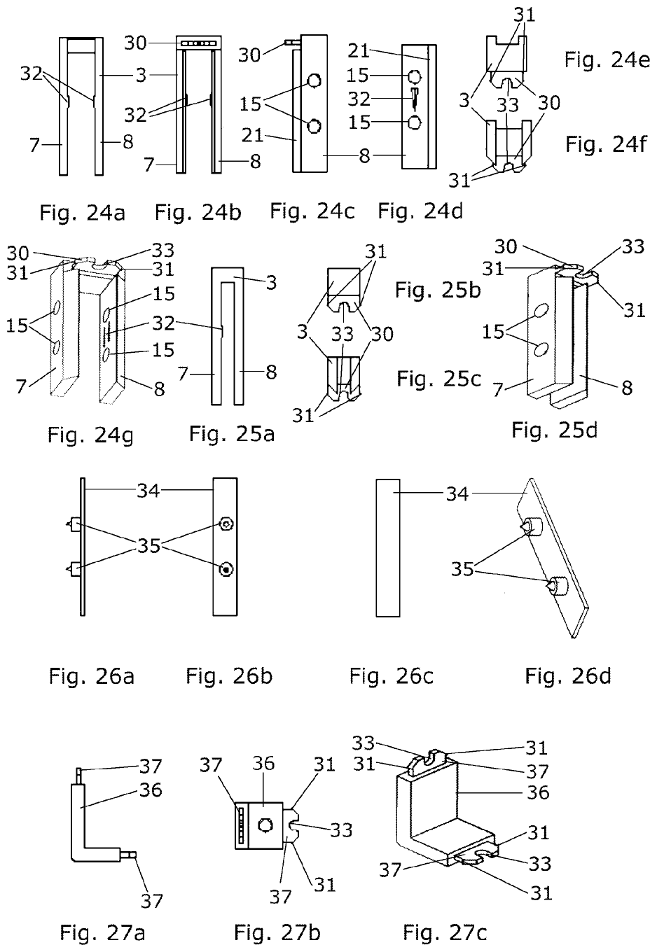

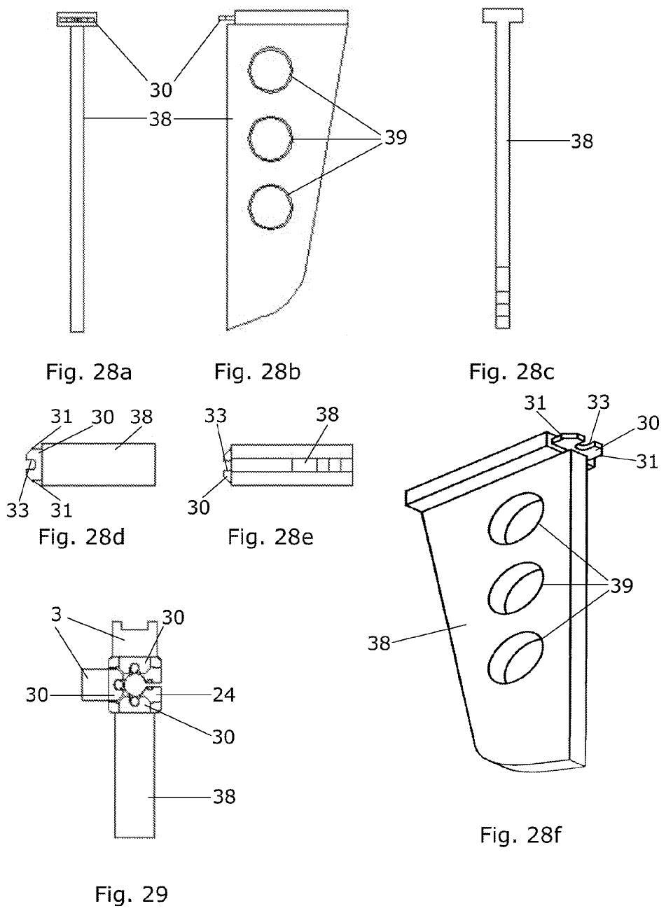

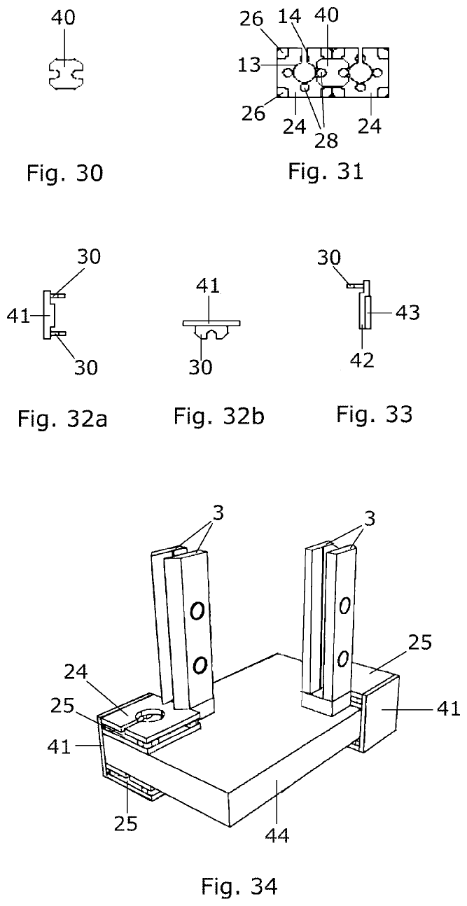

The invention is explained in more detail below with reference to an exemplary embodiment shown schematically in the drawing. FIG. 1 shows a first view of a connecting element according to the invention, FIG. 2 shows a second view of a connecting element according to the invention, FIGS. 3-6 show views of base plates according to the invention in four embodiments, FIG. 7 shows a side view and FIG. 8 a bottom view of the base plate according to the invention, FIG. 9 shows a connecting element according to the invention in a plan view with four receiving elements, FIG. 10 shows a connecting element according to the invention with four receiving elements in a view from below, FIG. 11 a connecting element according to the invention in a side view, FIGS. 12-16 a receiving element according to the invention, FIG. 17 a drawer divider with different connecting elements according to the invention, FIGS. 18 and 19 a second embodiment of a connecting element according to the invention, FIG. 20 a ground plate of a connecting element according to the invention, FIG. 21 a cover plate of a connecting element according to the invention, FIG. 22 a base plate according to the invention, FIG. 23 a ground plate with two incorporated receiving elements in the connected state, FIG. 24 an embodiment of a receiving element, FIG. 25 a further embodiment of a receiving element, FIG. 26 a cover element, FIG. 27 an angle element, FIG. 28 a terminal element, FIG. 29 a ground plate in the connected state with three different receiving elements or connecting pieces, respectively, FIG. 30 a double tab for connecting two base plates, FIG. 31 two base plates connected using a double tab, FIG. 32 a side part for connecting two base plates, FIG. 33 a fastening part and FIG. 34 a perspective view of a set according to the invention.

In FIG. 1 (perspective view from above) and FIG. 2 (perspective view from below), a first embodiment of a connecting element according to the invention is designated with 1. The connecting element 1 has a base plate 2 and a first receiving element 3, a second receiving element 4, a third receiving element 5 and a fourth receiving element 6. The receiving elements 3,4,5,6 each have first strips 7 and second strips 8, which are each arranged essentially perpendicular to the base plate 2 and essentially parallel to one another. The strips 7 and 8 are each connected via a bridge, which forms a U-shape in plan view together with the strips 7,8. The strips 7,8 of the first receiving element 3 form with the base plate 2 a first receiving groove 9, the strips 7,8 of the second receiving element 4 form with the base plate 2 a second receiving groove 10, the strips 7,8 of the third receiving element 5 form with the base plate 2 a third receiving groove 11 and the strips 7, 8 of the fourth receiving element 6 form with the base plate 2 a fourth receiving groove 12. The U-shape of the receiving elements 3,4,5,6 in plan view also creates a groove that is perpendicular to the receiving grooves 9,10,11,12. The axes of the receiving grooves 9,10,11,12 each enclose an angle of 90° with the respectively adjacent receiving groove 9,10,11,12, so that the receiving grooves 9,10,11,12 form a cross-shaped cavity (FIG. 2). The base plate 2 has a central opening 13 and a groove 14 connected to the opening 13. The strips 7,8 are each provided with a plurality of openings 15 which are arranged transversely to the course of the receiving grooves 9,10,11,12.

The first strips 7 and the second strips 8 each have surfaces which are essentially parallel and opposite to one another and which form a gap 16. The gaps 16 each extend to the base plate 2 and are delimited by it.

It can also be seen in FIG. 2 that the connecting element 1 is substantially 4-fold rotationally symmetrical.

In FIG. 3 a first embodiment of an inventive base plate 2 is shown. The base plate 2 has an opening 13, a continuous groove 14 and four tabs 17, which are used for connecting with receiving elements 3,4,5,6. Each tab 17 also has a groove 18.

FIG. 4 shows a second embodiment of the base plate 2, in which only three tabs 17 arranged in a T-shape are provided.

In FIG. 5 a third embodiment of the base plate 2 is shown, in which two tabs 17 are provided. The two tabs 17 are opposite each other.

In FIG. 6 a fourth embodiment of the base plate 2 is shown, in which two tabs 17 are provided which are at right angles to each other.

FIG. 7 shows a base plate 2 according to FIG. 3 in a side view. The tabs 17 are less thick than the central area of the base plate 2.

FIG. 8 shows a bottom view of a base plate 2 according to FIG. 3.

FIG. 9 shows a connecting element 1 according to the invention according to FIGS. 1 and 2 in a view from above.

FIG. 10 shows a connecting element 1 according to the invention as shown in FIGS. 1 and 2 in a view from below.

In FIG. 11 a connecting element 1 according to the invention is shown in a side view. 19 shows an opening in the receiving element 4 in which a tab 17 of the base plate 2 is arranged in order to connect the receiving element 4 to the base plate 2. Furthermore, the strips 7 and 8 of the receiving element 4 each have three connecting grooves 20 which are each arranged in the strips 7,8 in opposite directions. The middle connecting groove 20 is rectangular, the other two connecting grooves 20 are each formed in the shape of a segment of a circle.

FIG. 12 shows a receiving element 3 according to the invention in a front view. The receiving element 3 is U-shaped in this case.

FIG. 13 shows a receiving element 3 according to the invention in a side view. A slanting surface is designated with 21, which together with a surface of another receiving member 4 forms a gap 16 (FIG. 10).

FIG. 14 shows a receiving element 3 according to the invention in a plan view. In particular, it can be clearly seen that the two strips 7,8 are connected to one another by a bridge, with an area between the strips 7,8 being recessed and the receiving element 3 having a U-shape.

FIG. 15 shows a receiving element 3 according to the invention in a view from below.

In FIG. 16 a strip 7 of a receiving element 3 is shown in a profile view.

FIG. 17 shows a drawer division in a drawer 22, comprising several different connecting elements 2 according to the invention and various separating elements 23, which are held relative to one another by the connecting elements 2. The separating elements 23 can, for example, have a rectangular, square, oval or round cross section.

In FIG. 18 (perspective view from above) and FIG. 19 (perspective view from below), a second embodiment of a connecting element 1 according to the invention is shown, wherein the receiving elements 3,4,5,6 are rigidly connected with the base plate 2. The parts of the receiving elements 3,4,5,6 connecting the two strips 7,8 are integrally connected to the base plate 2. The strips 7,8 of the connecting element each have two opposing, diametrically opposed connecting grooves 20 in the shape of a segment of a circle. Furthermore, the base plate 2 has additional openings 13 in the corner areas.

A two-part embodiment of a base plate 2 according to the invention is shown in FIGS. 20 to 23. The base plate 2 comprises a ground plate 24 and a cover plate 25.

In FIG. 20, the ground plate 24 is shown in a view from above (FIG. 20a), a view from below (FIG. 20b), a side view (FIG. 20c) and a perspective view (FIG. 20d). In addition to a central opening 13 and a groove 14, the ground plate 24 has a corner element 26 in each of the corners, which comprises a first hook element 27 designed as a groove. Additionally, four first holding elements 28 designed as bolts are provided, which are each arranged at a distance from the edge of the plate.

In FIG. 21 a cover plate 25 in a view from above (FIG. 21a), a view from below (FIG. 21b), a side view (FIG. 21c) and a perspective view (FIG. 21d) is shown, which in the plan view has essentially the same shape or size, respectively, as the ground plate 24. In the middle of the cover plate 25 there is a central bolt 29 which is designed to cooperate with the opening 13 of the ground plate 24.

In FIG. 22, the base plate 2, consisting of the ground plate 24 and the cover plate 25 is shown in the connected state.

In FIG. 23, the ground plate 24 is shown together with two tabs 30, each part of a receiving element 3,4. The tabs 30 are partially trapezoidal in plan view and have second hook elements 31 which, in the illustrated connected state, engage in the first hook elements 27 and thereby provide a connection between the base plate 2 and the receiving elements 3,4.

In FIG. 24, a first receiving element 3 designed for connection to a ground plate 24 is shown in a front view (FIG. 24a), a rear view (FIG. 24b), a side view (FIG. 24c), a view of a strip from the inside (FIG. 24d), a plan view (FIG. 24e), a view from below (FIG. 24f) and a perspective view (FIG. 24g). The receiving element 3 has two strips 7,8 that form a groove. The receiving element 3 has a tab 30 which is designed to be arranged between a ground plate 24 and a cover plate 25 and thus to connect the receiving element 3 to the base plate 2. A wedge-shaped elevation 32 is arranged on the mutually facing sides of the strips 7,8, which exerts a selective pressure on a separating element arranged in the receiving element 3 in order to hold it better in the receiving element 3. In addition to the second hook elements 31, the tab 30 also includes second holding elements 33 designed as round depressions, which interact with the first holding elements 28 in the connected state.

In FIG. 25, a second receiving element 3 designed for connection to a base plate 24 is shown in a front view (FIG. 25a), a plan view (FIG. 25b), a view from below (FIG. 25c) and a perspective view (FIG. 25d). In contrast to the embodiment according to FIG. 24, the outer edges of the two strips 7,8 are arranged flush with the outer edges of the tab 30 and the bridge is arranged flush with the strips 7,8.

In FIG. 26, a cover element 34 for covering openings 15 of the receiving element 3 is shown in a side view (FIG. 26a), a plan view (FIG. 26b), a view from below (FIG. 26c) and a perspective view (FIG. 26d). The cover member 34 has two protruding bolts 35 for connection with the openings 15 to cover the openings 15 selectively. The number of bolts 35 on the cover element 34 corresponds to the number of openings 15 of the strip to be covered. In order to enable the bolts 34 to be inserted more easily into the openings 15 and to fix separating elements 23 in place, the bolts 34 each have a point.

FIG. 27 shows an angle element 36 in a side view (FIG. 27a), a plan view (FIG. 27b) and a perspective view (FIG. 27c). The angle element 36 has two tabs 37 which correspond to the tabs 30 of the receiving elements 3,4 and each have a trapezoidal shape when viewed from above, second hook elements 31 and second holding elements 33. The tabs 37 are arranged in two mutually perpendicular planes and serve to connect two base plates 2 to one another.

In FIG. 28 a terminal element 38 is shown in a view from behind (FIG. 28a), a side view (FIG. 28b), a view from the front (FIG. 28c), a plan view (FIG. 28d), a view from below (FIG. 28e) and a perspective view (FIG. 28f). The terminal element 38 comprises a tab 30 which corresponds to the tabs 30 of the receiving elements 3, 4 or the tabs 37 of the angle element 36 and has a trapezoidal shape when viewed from above, second hook elements 31 and second holding elements 33. The terminal element 38 can be connected to a correspondingly designed base plate 2 and serves, for example, as a separating element. Furthermore, the terminal element 38 comprises a plurality of openings 39 which are designed, for example, to accommodate round separating elements.

FIG. 29 shows a ground plate 24 according to FIG. 20, which is connected to receiving elements 3 and a terminal element 38 through tabs 30.

FIG. 30 shows a plan view of a double tab 40 for connecting two ground plates 24 arranged in one plane.

FIG. 31 shows a double tab 40 which is connected to two ground plates 24.

FIG. 32 shows a side view (FIG. 32a) and a plan view (FIG. 32b) of a side part 41. The side part 41 comprises two tabs 30 arranged one above the other, which are provided for connection to base plates 2 formed by ground plates 24 and cover plates 25. This enables two base plates 2 to be connected to one another.

FIG. 33 shows a side view of a fastening part 42, which has a tab 30 and a vacuum pad designed as a fastening element 43. The fastening element 43 enables a non-slip connection to the body or to the side parts of the drawer.

FIG. 34 shows a perspective view of the ground plate 24, cover plate 25, receiving elements 3 and side parts 42, which are connected to a vertical plate 44.

1. Connecting element, comprising a base plate (2) at least a first receiving element (3) and at least a second receiving element (4), wherein the base plate (2) is connected to the first receiving element (3) and a-the second receiving element (4), wherein the first receiving element (3) and the second receiving element (4) each have a first strip (7) and a second strip (8), which are each arranged essentially perpendicular to the base plate (2), wherein the first and the second strip (7,8) of the first receiving element (3) and the base plate (2) delimit a first receiving groove (9), which is designed to receive a separating element, and the first and the second strip (7,8) of the second receiving element (4) and the base plate (2) delimit a second receiving groove (10) which is designed to receive a separating element, wherein the axis of the first receiving groove (9) and the axis of the second receiving groove (10) enclose an angle of approximately 90°, characterized in that the second strip (8) of the first receiving element (3) and the first strip (7) of the second receiving element (4) have opposing surfaces (21) that are substantially parallel to one another and form a gap (16).

2. Connecting element according to claim 1, wherein the first and/or the second strip (7,8) of the first and/or the second receiving element (3,4) are arranged in a resilient manner.

3. Connecting element according to claim 1, wherein the base plate (2) has at least one opening (13).

4. Connecting element according to claims 1, wherein at least the first and/or the second receiving element (3,4) is detachably connected to the base plate (2).

5. Connecting element according to claim 1, wherein the first strip (7) and/or the second strip (8) of the first and/or the second receiving element (3,4) has a connecting groove (20).

6. Connecting element according to claim 1, wherein the first and/or the second strip (7,8) of the first and/or the second receiving element (3,4) has at least one opening (15), which is preferably arranged transversely to the axis of the receiving groove (9,10).

7. (canceled)

8. (canceled)

9. (canceled)

10. Connecting element according to claim 1, wherein a third and a fourth receiving element (5,6) are provided, which are connected to the base plate (2), wherein the strips of the receiving elements (3,4,5,6) and the base plate (2) delimit a cavity which is cross-shaped in a view from below.

11. Set, comprising a connecting element according to claim 1, in which at least one of the receiving elements (3,4) can be detachably connected to the base plate (2), with at least one additional connecting piece being provided which can be connected to the base plate (2).

12. Set according to claim 11, wherein an angle element (36) which can be connected to a base plate (2) on two sides is provided.

13. Set according to claim 11 wherein a double tab (40) is provided, which is designed to connect two base plates (2) lying in one plane to one another in such a way that the base plates (2) touch one another.

14. Set according to claim 11 wherein a side part (41) is provided which has two parallel tabs (30) which are each designed to be connected to a base plate (2).

15. Set according to claim 11, wherein a fastening part (42) is provided, which has a tab (30) for connection to a base plate (2) and a fastening element (43).
